(19) United States
(12) Patent Application Publication
(10) Pub. No.: US 2025/0349292 A1
(43) Pub. Date: Nov. 13, 2025

(54) COMPLIANCE DETECTION USING NATURAL LANGUAGE PROCESSING

(71) Applicants: American Express Travel Related Services Company, Inc., New York, NY (US); Amex Canada, Inc., Toronto (CA)

(72) Inventors: Anand Chandramohan, Phoenix, AZ (US); Krittika Ranganath Nayak, Mississauga (CA); Nicole Mingie, Phoenix, AZ (US); Judith Hannah Rosenke, Phoenix, AZ (US); Shanmuga Krishnamurthy, Phoenix, AZ (US); Donna Tamara Peters, Pembroke Pines, FL (US); Asoj Cherukat, Weston, FL (US); Jeffrey M. Walker, Scottsdale, AZ (US); Lan Anh A. Hoang, Brooklyn, NY (US); Srivatsan Srinivasan, Phoenix, AZ (US)

(21) Appl. No.: 18/660,426

(22) Filed: May 10, 2024

(51) Int. Cl. G10L 15/19; G10L 15/26

(52) U.S. Cl. CPC G10L 15/19; G10L 15/26

(57) ABSTRACT

Disclosed are various embodiments for compliance detection using natural language processing. Various embodiments include a computing device that can receive an audio signal representing at least a spoken statement and receive a text statement of a script. Various embodiments can then transcribe the audio signal into a transcript and standardize the transcript into a standardized transcript. Various embodiments can then perform a sequence matching to determine a confidence score, the confidence score representing a likelihood that the text statement matches the standardized transcript. Various embodiments can direct an agent device based on the sequence matching.

### BACKGROUND

Laws, regulations, and industry standards often require businesses to keep recordings of phone calls for various purposes. At least one purpose is to ensure that representatives of the business are not violating any laws, regulations, or industry standards when speaking with clients or potential clients. A representative of the business can be required to recite specific words to ensure compliance. Quality assurance review teams are required to inspect random calls long after they have been completed to review whether the representative of the business satisfied the compliance standards, even though the damage may have already been done.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of a network environment according to various embodiments of the present disclosure.

FIG. 2 is a pictorial diagram of an example user interface rendered by an agent device in the network environment of FIG. 1 according to various embodiments of the present disclosure.

FIG. 3 is a flowchart illustrating one example of functionality implemented as portions of an application executed in an agent device in the network environment of FIG. 1 according to various embodiments of the present disclosure.

FIG. 4 is a flowchart illustrating one example of functionality implemented as portions of an application executed in a computing environment in the network environment of FIG. 1 according to various embodiments of the present disclosure.

FIGS. 5A-F are pictorial diagrams that provide an example of performing a sequence match on a computing environment in the network environment of FIG. 1 according to various embodiments of the present disclosure.

FIG. 6 is a sequence diagram illustrating interactions between various components of the network environment of FIG. 1 according to various embodiments of the present disclosure.

### DETAILED DESCRIPTION

Disclosed are various approaches for compliance detection using natural language processing. Businesses can enforce compliance rules to ensure that the business is compliant with laws, regulation, and/or industry standards. Agents or representatives of the company can communicate with clients or prospective clients in various ways, such as over audio chat systems (e.g., telephone, voice over internet protocol (VOIP), etc.), text-based chat systems (e.g., multimedia messaging service (MMS), short message service (SMS), web-based chat systems, etc.), and audio/video chat systems (e.g., Skype®, FaceTime®, etc.). To ensure compliance when agents of the business communicate with clients or prospective clients, it can be important that the agent conveys accurate and consistent information to the client or prospective client during the communication. Businesses often provide agents with a script to ensure that the compliant language is communicated verbatim. However, even agents that have a script can unintentionally mislead or provide false information by omitting words from the script, going off-script, speaking too quickly, not speaking clearly, or various other concerns when communicating with clients or prospective clients. There has been no good way to provide an agent with immediate feedback during or immediately after a call has been completed.

Instead, to verify compliance, businesses often hire compliance reviewers. Compliance reviewers are people who evaluate actions taken by agents of the business and determine whether the action was compliant with the relevant laws, regulations, and/or industry standards. However, feedback from the compliance reviewer often cannot undo or prevent a compliance violation from occurring, but rather the feedback can only provide feedback only after the damage has been done. Further, compliance reviewers can only review a limited number of communications between clients or prospective clients and agents each day due to the manual process of listening to each communication. For example, a compliance reviewer can evaluate a phone call between an agent of the company and a client (or a prospective client) that extends over a long period of time (e.g., an hour or more, etc.). In such a situation, the compliance reviewer would be limited to reviewing only a few phone calls in a standard workday. Further, various laws and regulations could limit the number of work hours that a compliance reviewer can perform in a workday to ensure that the compliance reviewer stays sharp and is not overburdened. In turn, fewer communications can be reviewed in the limited workday. Accordingly, there is a need in the industry to decrease the number of communications that a compliance reviewer must review. Further, a need exists in the industry to allow compliance reviewers to focus on more significant compliance concerns rather than sampling each and every call. Even further, a need exists for compliance feedback at an earlier stage so that an agent can prevent or correct a compliance violation from occurring.

In some industries, a business could have hundreds of thousands of communications between agents of the business and a client or prospective client each day. Because there are so many communications that would need to be evaluated by compliance reviewers, businesses have permitted compliance reviewers to sample select actions to evaluate the compliance as a representation of a group of communications taken by each agent. In other words, the compliance reviewers cannot review each and every communication, so only a small percentage of communications can be evaluated. This means that infractions that can occur in a non-evaluated communication could be ignored by the business because it would be impossible or impractical to hire the necessary compliance reviewers to evaluate each call manually.

To solve these problems, a real-time natural-language processing compliance system can be used to guide agents of the business when communicating with clients or potential clients. While communicating with the client or potential client, the agent can identify a portion of the script that needs to be read to the client or potential client and read such portion aloud. The real-time natural-language processing compliance system can then convert that speech to text, verify that the text matches the portion of the script with reasonable certainty, and indicate to the agent that the portion of the script that was read aloud to the client or potential client was compliant or non-compliant. When a portion of the script is non-compliant, the agent can be prompted (in real-time) to read the portion of the script aloud again to ensure compliance.

This feedback can be sent to the agent for every line of a disclosure, which can provide opportunities for the agent to course correct compliance concerns immediately. This allows opportunities for agent to re-read the disclosures, for customers can ask questions (which may interrupt the flow of the agent), and for the feedback to increase awareness and confidence for a more robust sales practice in a timely fashion. This solution strengthens sales practice effectiveness by providing feedback to agents and operations teams to review if all information was relayed to customers during the call. By doing this, an emphasis is placed on assisting agents ensure that all offer details are correctly conveyed to the customer. Further, by ensuring compliance using a real-time natural-language processing compliance system, compliance reviewers could entirely forego reviewing a portion of the communication that corresponds to the agent following the script verbatim, which could allow the compliance reviewer to review more communications for other violations.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

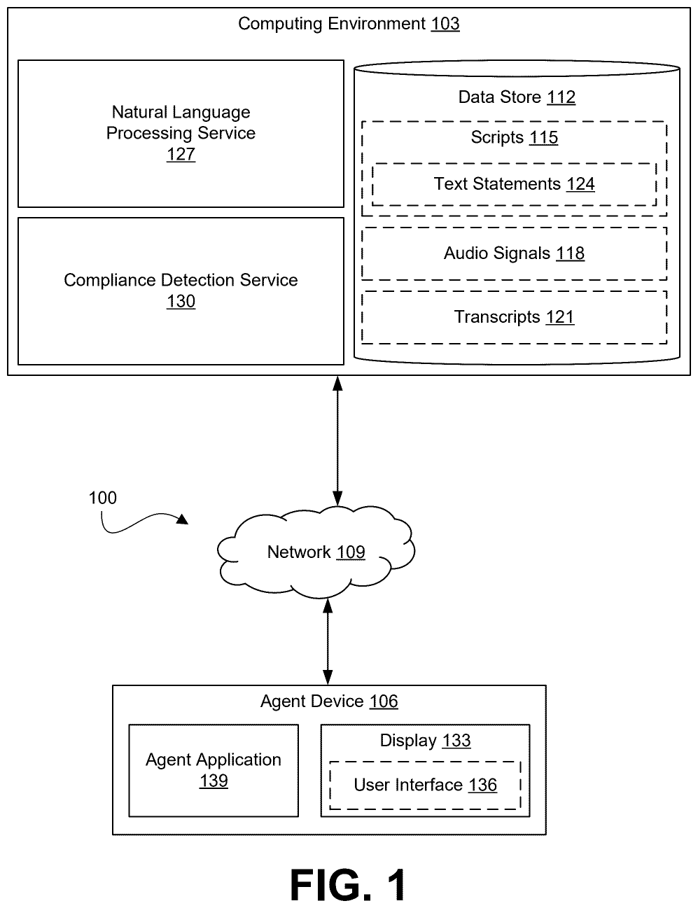

With reference to FIG. 1, shown is a network environment 100 according to various embodiments. The network environment 100 can include a computing environment 103 and an agent device 106, which can be in data communication with each other via a network 109.

The network 109 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (e.g., WI-FI®), BLUETOOTH® networks, microwave transmission networks, as well as other networks relying on radio broadcasts. The network 109 can also include a combination of two or more networks 109. Examples of networks 109 can include the Internet, intranets, extranets, virtual private networks (VPNs), and similar networks.

The computing environment 103 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the computing environment 103 can employ a plurality of computing devices that can be arranged in one or more server banks or computer banks or other arrangements. Such computing devices can be located in a single installation or can be distributed among many different geographical locations. For example, the computing environment 103 can include a plurality of computing devices that together can include a hosted computing resource, a grid computing resource, or any other distributed computing arrangement. In some cases, the computing environment 103 can correspond to an elastic computing resource where the allotted capacity of processing, network, storage, or other computing-related resources can vary over time.

Various data can be stored in a data store 112 that can be accessible to the computing environment 103. The data store 112 can be representative of a plurality of data stores 112, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store 112. The data stored in the data store 112 is associated with the operation of the various applications or functional entities described below. This data can include scripts 115, audio signals 118, transcripts 121, and potentially other data.

The scripts 115 can represent a series of statements related to at least one topic that an agent can communicate to a client (or prospective client). A script 115 can include a title to identify a purpose for the script 115. A script can also include one or more text statements 124. The text statements 124 can represent statements that an agent can communicate to a client (or prospective client). The text statements 124 can include a plurality of words, numbers, and symbols in a standardized format. In various embodiments, a text statement 124 can represent a single sentence. In some embodiments, a text statement 124 can represent one or more sentences. Because an agent's voice communicating a text statement 124 is being captured in the audio signals 118 (which can be transferred to a compliance detection application 130), then the fewer words a text statement 124 often correlates to the amount of time an audio signal 118 captures the communication of the agent. The text statements 124 can be sorted into a specified order in the script 115. Text statements 124 can also be grouped into required statements to fulfill compliance for the entire script 115 and non-required statements to fulfill compliance for the entire script 115. Additionally, text statements 124 can be grouped into logical groups to make proceeding through the entire script 115 easier. Groupings may not be visible or ascertainable via a user interface 136.

The audio signals 118 can represent a call, discussion, or communication between at least an agent and a client (or prospective client). For various compliance purposes, calls, discussions, or communications between an agent and a client can be recorded as audio signals 118. The audio signals 118 can be stored as one or more audio files in various formats that can be used for playback, such as a Waveform Audio file format (.WAV), an MPEG Audio Layer 3 file format (.MP3), a Windows® Media Audio file format (.WMA), and/or other audio file formats. In various embodiments, the audio signals 118 can be captured real-time from an active call, discussion, or communication between at least an agent and a client (or prospective client). In various embodiments, a telephone signal can be converted to an audio signal and sent to at least one of an agent device 106 and a computing environment 103. In various embodiments, a digital VOIP signal can be sent to at least one of an agent device 106 and a computing environment 103. In various embodiments, real-time audio signals 118 can be combined into a single audio signal 118 that can represent a complete statement made by at least one of an agent or a client.

The transcripts 121 can represent a text interpretation of a call or discussion between at least an agent and a client (or prospective client). In at least some embodiments, a transcript 121 can be generated by transcribing a call or discussion from audio signals 118. In at least another embodiment, a transcript 121 can be generated by transcribing a call or discussion from audio signals 118 as it is actively occurring. In some embodiments, the transcript 121 can be representative of just the statements that were made during the call. Because many natural language processing services 127 use best estimates to transcribe audio to text and because people can use language that can be difficult to decipher, a transcript 121 can also include unintended errors, incomplete words, and/or incomplete sentences. In some embodiments, the transcript 121 can identify one or more speakers to provide context to the flow of the discussion or call. In at least one example, the transcript 121 can have a first speaker identified as an agent. Similarly, the transcript 121 can have a second speaker identified as a client. In some embodiments, the transcript 121 can include a date and timestamp corresponding to when each statement was made. In some embodiments, the transcript 121 can include a time counter that marks the time that has elapsed since the start of the call or discussion. Although these time counters often measure in seconds, they could measure in minutes or other units of time.

A transcript 121 can be standardized to generate a standardized transcript. In some embodiments, standardizing a transcript 121 can involve replacing a number word (e.g., “one,” “two,” etc.) from the transcript 121 with a corresponding number integer (e.g., “1,” “2,” etc.). In some embodiments, standardizing a transcript 121 can involve replacing a symbol word (e.g., “point,” “percent”, etc.) from the transcript with a symbol character (e.g., “.”, “%”, etc.). In some embodiments, standardizing a transcript 121 can involve lemmatizing various words to a standard-form word. For example, the word “do” can be represented in past tense with “did,” as a past participle with “done,” as a present participle with “doing,” and a third-person singular form with “does.” In such an example, standardizing a transcript 121 could include replacing any instance of “did,” “done,” “doing,” or “does” as “do.” In some embodiments, standardizing a transcript 121 can involve replacing a contraction word (e.g., “aren't,” “can't,” “I'm,” “they're,” “she'll,” etc.) from the transcript with corresponding non-contraction words (e.g., “are not,” “cannot,” “I am,” “they are,” “she will,” etc.). In some embodiments, standardizing a transcript 121 can involve removing extraneous spacing and extraneous punctuation. Because many natural language processing services 127 use best estimates to transcribe audio to text and because people can use language that can be difficult to decipher, a transcript 121 can also include unintended errors, incomplete words, and/or incomplete sentences. In various embodiments, standardizing a transcript 121 can remove unintended errors, incomplete words, and/or incomplete sentences. A standardized transcript can be analyzed by a compliance detection service 130 to determine whether portions of the call or discussion between at least the agent and the client (or prospective client) match a text statement 124 of a script 115.

Also, various applications or other functionality can be executed in the computing environment 103. The components executed on the computing environment 103 can include a natural language processing service 127, a compliance detection service 130, and other applications, services, processes, systems, engines, or functionality not discussed in detail herein.

The natural language processing service 127 can be executed to transcribe one or more audio signals 118 into a transcript 121. The natural language processing service 127 can receive an audio signal 118 from at least one of an agent application 139 on an agent device 106 or from the compliance detection service 130 of the computing environment 103. In various embodiments, the natural language processing service 127 can perform pre-processing on the audio signals 118, such as noise reduction, filtering, and normalization to improve the quality of the audio signal, which can enhance the accuracy of the transcription. In various embodiments, the natural language processing service 127 can perform at least one of the noise reduction, filtering, or normalization repeatedly until the audio signal 118 has a sufficient clarity to begin processing the audio signal 118. Noise reduction can reduce background noise (e.g., a consistent hissing, a consistent humming, a consistent crackle, etc.) in an audio signal 118 with a minimal reduction in audio signal 118 quality. Filtering can be used amplify or boost chosen frequency ranges in the audio signal 118 (e.g., increase the prominence of certain sounds in the audio signal 118, etc.). Filtering can also be used to pass or attenuate chosen frequency ranges in the audio signal 118 (e.g., decrease the prominence of certain sounds in the audio signal 118, etc.). Normalization can increase or decrease the amplitude of an audio signal 118 to bring the amplitude to a target level. The natural language processing service 127 can also perform various other pre-processing transformations to the audio to enhance the clarity and/or concision of the audio signal 118.

The natural language processing service 127 can extract relevant features from the audio signal, such as frequency components, phonetic characteristics, and other acoustic information. The natural language processing service 127 can use the extracted features with various algorithms, like Hidden Markov Models, neural networks (including convolutional neural networks or recurrent neural networks), transformers (e.g., Bidirectional Encoder Representations from Transformers (“BERT”), Generative Pre-trained Transformer (“GPT”), etc.), or other models. The natural language processing service 127 can employ language models to improve accuracy by considering context of the words spoken. The natural language processing service 127 can output a transcript 121 in written form. Because many natural language processing services 127 use best estimates to transcribe audio to text and because people can use language that can be difficult to decipher, a transcript 121 can often include unintended errors, incomplete words, and/or incomplete sentences.

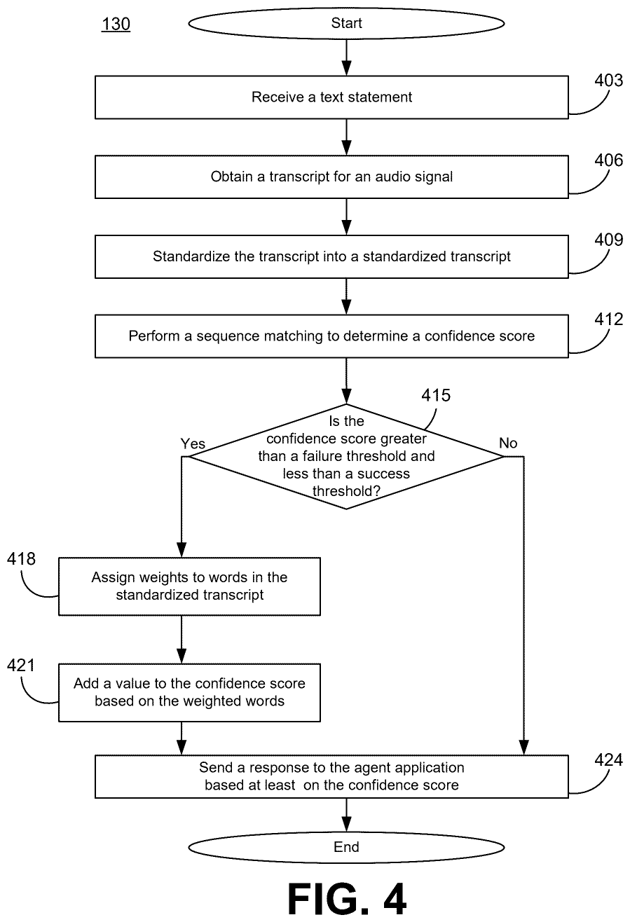

The compliance detection service 130 can be executed to perform various functions. In various embodiments, the compliance detection service 130 can receive at least an audio signal 118 from an agent application 139. The compliance detection service 130 can receive a text statement 124 that corresponds to the audio signal 118 received from the agent application 139. The compliance detection service 130 can transcribe the audio signal 118 into a transcript 121 using the natural language processing service 127. The compliance detection service 130 can standardize the transcript 121 into a standardized transcript 121. The compliance detection service 130 can perform a sequence matching to determine a confidence score that indicates how well the standardized transcript 121 matches the corresponding text statement 124. The compliance detection service 130 can determine whether the confidence score is both greater than a failure threshold value and less than a success threshold value. The compliance detection service 130 can assign weights to words in the standardized transcript 121. The compliance detection service 130 can add a value to the confidence score based at least in part on the weight words in the standardized transcript 121. The compliance detection service 130 can send a response to the agent application 139 based at least in part on the confidence score. Additional information regarding the compliance detection service 130 is further described in the discussion of FIG. 4.

The agent device 106 can represent a plurality of client devices that can be coupled to the network 109. The agent device 106 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The agent device 106 can include one or more displays 133, such as liquid crystal displays (LCDs), gas plasma-based flat panel displays, organic light emitting diode (OLED) displays, electrophoretic ink (“E-ink”) displays, projectors, or other types of display devices. In some instances, the display 133 can be a component of the agent device 106 or can be connected to the agent device 106 through a wired or wireless connection.

The agent device 106 can be configured to execute various applications, such as an agent application 139 or other applications. The agent application 139 can be executed in an agent device 106 to access network content served up by the computing environment 103 or other servers, thereby rendering a user interface 136 on the display 133. To this end, the agent application 139 can include a browser, a dedicated application, or another executable, and the user interface 136 can include a network page, an application screen, or another user mechanism for obtaining user input. The agent device 106 can be configured to execute applications beyond the agent application 139, such as email applications, social networking applications, word processors, spreadsheets, or other applications.

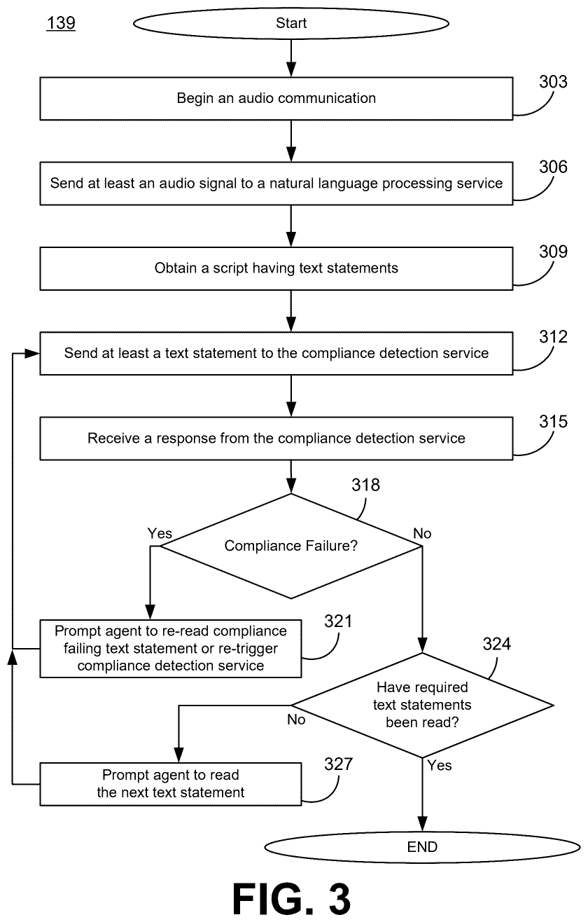

Additionally, the agent application 139 can perform various actions. For instance, the agent application 139 can begin an audio communication. The agent application 139 can obtain a script 115 having one or more text statements 124. The agent application 139 can send at least an audio signal 118 (or audio signals 118) to a compliance detection service 130. The agent application 139 can receive a response from the from the compliance detection service 130. The agent application 139 can determine if the response indicates that there was a compliance failure for matching the text statement 124. The agent application 139 can prompt the agent to again vocalize or re-read the text statement 124 that the response indicated was a compliance failure. The agent application 139 can determine whether each of the required text statements 124 in the script 115 have successfully passed compliance for the audio communication. The agent application 139 can prompt the agent to read or vocalize a next text statement 124. Additional information regarding the agent application 139 is further described in the discussion of FIG. 3.

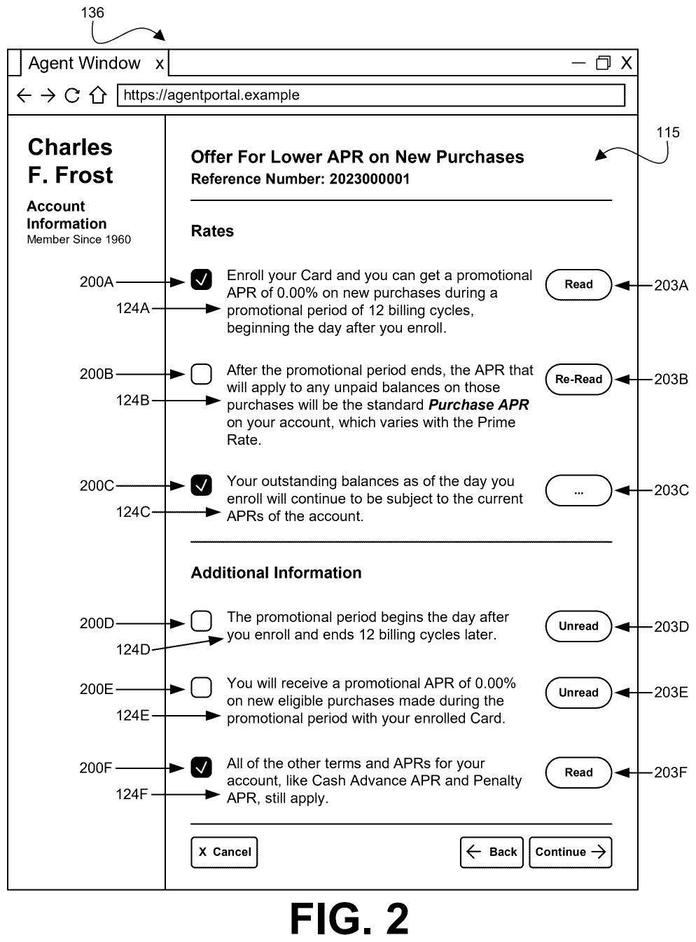

Referring next to FIG. 2, shown is a pictorial diagram of an example user interface 136 rendered by an agent device 106 in the network environment 100 of FIG. 1 according to various embodiments of the present disclosure. The user interface 136 can include various elements to navigate in an application, such as a browser, such as navigation affordances (e.g., forward button, backward button, refresh button, home button, etc.), a navigation text input, and various other elements to navigate in an application. The user interface 136 of FIG. 2 represents an example script 115, presented in a browser, that is displayed on the display 133 of the agent device 106.

In the user interface 136 of FIG. 2, the example script 115 is presented upon obtaining the script from the computing environment 103. The script 115, as shown in the user interface 136 of FIG. 2, is directed to an “offer for lower APR on new purchases.” The user interface 136 can include text statements 124A-F of a script 115, one or more completion affordances 200A-F (generically as “completion affordances 200” or individually as “completion affordance 200”), and status indicators 203A-F (generically as “status indicators 203” or individually as “status indicator 203”). A text statement 124 can correspond to both a completion affordance 200 and a status indicator 203. As shown in FIG. 2, text statement 124A corresponds to completion affordance 200A and status indicator 203A, text statement 124B corresponds to completion affordance 200B and status indicator 203B, text statement 124C corresponds to completion affordance 200C and status indicator 203C, text statement 124D corresponds to completion affordance 200D and status indicator 203D, text statement 124E corresponds to completion affordance 200E and status indicator 203E, text statement 124F corresponds to completion affordance 200F and status indicator 203F.

The completion affordances can be used to indicate to the agent application 139 that a corresponding text statement has been read to a client, as captured in the audio signals 118. In at least some embodiments, completion affordances 200 can be represented as checkboxes, as shown in FIG. 2. As an example, an agent can click a blank checkbox completion affordance (e.g., completion affordance 200B, completion affordance 200D, completion affordance 200E, etc.) to indicate that the previous portion of the audio signals 118 includes the agent's voice reading a text statement 124 (e.g., text statement 124B, text statement 124D, text statement 124E, etc.). In such embodiments, the agent application 139 can prompt an agent to re-read a text statement 124 that fails to pass compliance (See FIG. 3, block 315 and block 321) and the completion affordance 200 can automatically be unchecked to reflect that the agent has not successfully completed reading the text statement 124, which is shown with respect to completion affordance 200B. In other embodiments, a completion affordance 200 can be represented as a drop-down selection input, a text input, or another input that would allow the agent to indicate that the corresponding text statement 124 has been read to the client.

The status indicators 203 can indicate a status as it relates to whether an agent has vocalized the corresponding text statement 124. The status indicators 203 can indicate a variety of different statuses. For example, a status indicator 203 could indicate that a corresponding text statement 124 has been read or has not been read. The status indicator 203 could also indicate that a compliance detection service 130 is currently processing the audio signal 118 produced from reading the corresponding text statement 124. The status indicator 203 could also indicate that the agent application 139 is listening for a corresponding text statement 124 to be read aloud or otherwise vocalized. The status indicator 203 can also indicate that a status for the corresponding text statement 124 is not currently available or that the compliance detection service 130 is not currently available for detecting compliance. Various other statuses can be displayed for various other purposes.

The status indicators 203 can use text, colors, or symbols to indicate the status within the status indicators 203. For example, a status indicator 203 can use gray to indicate that a statement has not yet been vocalized to a client, red to indicate that the vocalization as recorded in the audio signals 118 has failed to match the text statement 124, green to indicate that the vocalization as recorded in the audio signals 118 matches the text statement 124, yellow to indicate that the agent must re-read or again vocalize the text statement 124 to the client, or various other colors for various other statuses. Various symbols could be used, such as emojis or shapes could be used. For example, an “X” or an exclamation point can be used to indicate a failure to match, a smiley face emoji could be used to indicate a match is successful, or various other symbols.

Additionally, text could be used to indicate the status within the status indicators 203. As shown in FIG. 2, status indicator 203A and status indicator 204F include a text status of “Read” to indicate that the vocalized statement matches corresponding text statements 124, i.e., text statement 124A and text statement 124F. Status indicator 203B includes a text status of “Re-Read” to indicate that the vocalized statement did not match the corresponding text statement 124B. Status indicator 203C includes a text status of “ . . . ” to indicate that the agent application 139 is waiting or pending a response from a compliance detection service 130. Alternatively, status indicator 203C could be used to indicate to the agent that the agent application 139 is listening currently for the corresponding text statement 124C to be read aloud or otherwise vocalized. Status indicator 203D and status indicator 203E include a text status of “Unread” to indicate that the agent has not yet vocalized the corresponding text statements 124, i.e., text statement 124D and text statement 124E. Although FIG. 2 depicts certain words, phrases, and/or symbols for the statuses of the status indicators 203, it should be understood that other words, phrases, symbols, colors, shapes, or other visual representations of a status can be used to communicate a status.

In at least some embodiments, a portion of the text statement 124 can be highlighted or emphasized to demonstrate that such a portion of the text statement 124 was not clearly recognized by the compliance detection service 130. For example, text statement 124C depicts the words “Purchased APR” emphasized to indicate to the agent that the portion of the text statement 124C was not vocalized clearly or the compliance detection service 130 had trouble identifying those words in the audio signals 118.

Referring next to FIG. 3, shown is a flowchart that provides one example of the operation of a portion of the agent application 139. The flowchart of FIG. 3 provides merely an example of the many different types of functional arrangements that can be employed to implement the operation of the depicted portion of the agent application 139. As an alternative, the flowchart of FIG. 3 can be viewed as depicting an example of elements of a method implemented within the network environment 100.

Beginning with block 303, the agent application 139 can begin an audio communication. An agent can begin a communication with a client over a medium which can be captured as an audio signal 118, such as a telephone call, a VOIP call, or a video call. In some embodiments, the audio signal 118 can be streamed to the agent device 106. In some embodiments, the audio signals 118 can be recorded and stored to a data store 112. During the communication, an event can occur that prompts the agent to access a script 115 to ensure that the communication meets compliance standards. For instance, the client can indicate that they want to sign up for a service or purchase a product. If a client indicates that they want to sign up for a service or purchase a product, the agent can then access a corresponding script 115 to guide the agent in signing the client up for the service or assisting the client in purchasing the product.

Continuing to block 306, the agent application 139 can send at least an audio signal 118 (or audio signals 118) to the natural language processing service 127. In at least some embodiments, the agent application 139 can send additional information to the natural language processing service 127 and/or to the compliance detection service 130 that can identify a specific text statement 124 within a script 115 to which the audio signal 118 corresponds, as further discussed at block 312. The agent application 139 can send the audio signal 118 to the natural language processing service 127 to generate a transcript 121 of the audio signal 118. In various embodiments, the agent application 139 can send the audio signal 118 to the natural language processing service 127 on or around the beginning of the communication to ensure that a complete transcript 121 of the communication is made. In at least some embodiments, the agent application 139 can send the audio signal 118 to the natural language processing service 127 in response to obtaining a script at block 309.

Next, at block 309, the agent application 139 can obtain a script 115 having one or more text statements 124. As previously discussed, in at least some embodiments, the agent application 139 can obtain a script 115 prior to sending an audio signal 118 as described in box 306. In some embodiments, an agent can interact with the agent application 139 to select specified script 115 with which the agent wishes to proceed. For instance, the client can indicate that they wish to sign up for a service or purchase a product. If a client indicates that they wish to sign up for a service or purchase a product, the agent can then access a corresponding script 115 to guide the agent in signing the client up for the service or assisting the client in purchasing the product. In some embodiments, the agent application 139 can detect that a specific script 115 should be used by the agent as the communication continues. In at least some embodiments, the agent application 139 can send additional information to the natural language processing service 127 and/or to the compliance detection service 130 that can identify a specific text statement 124 within a script 115 to which the audio signal 118 corresponds. By sending the additional information, the natural language processing service 127 and/or the compliance detection service 130 can further enhance their respective functionality by having the additional information.

In various embodiments, the scripts 115 can be obtained from the data store 112 on the computing environment 103. In such embodiments, the agent application 139 can send a request to the computing environment 103 to obtain a specified script 115. In response, the computing environment 103 can send the script 115 to the agent application 139, which the agent application 139 can receive. In some embodiments, the agent device 106 can cache scripts 115 on the agent device 106, such that obtaining a script 115 from the data store 112 on the computing environment 103 becomes unnecessary. In such embodiments, the agent application 139 can store the scripts 115 in a cache on the agent device 106. In such embodiments, the agent application 139 can request a specified script 115 from the cache of the agent device 106 as needed and the agent application 139 can receive the script 115. The scripts 115 can represent a series of statements related to at least one topic that an agent can communicate to a client (or prospective client). A script 115 can include a title to identify a purpose for the script 115. A script can also include one or more text statements 124. The text statements 124 can represent statements that an agent can communicate to a client (or prospective client). The text statements 124 can include a plurality of words, numbers, and symbols in a standardized format. The script 115 can be displayed on the user interface 136 of the display 133, as previously described in the discussion of FIG. 2.

Continuing to block 312, the agent application 139 can send at least a text statement 124 to the compliance detection service 130. In at least some embodiments, an agent application 139 can receive input (e.g., via a confirmation affordance 200 on a user interface 136, etc.) from an agent that indicates that a specified text statement 124 (or more than one text statements 124) has been vocalized or read aloud and captured in the audio signal 118. In such embodiments, the agent application 139 can send the text statement(s) 118 or identifiers for the text statements 118 to the compliance detection service 130. In some embodiments, the agent application 139 can send at least an audio signal 118 (or audio signals 118) to the natural language processing service 127 in response to receiving input from an agent that indicates that a specified text statement 124 has been vocalized or read aloud and captured in the audio signal 118.

In at least some embodiments, the agent application 139 can send additional information to the natural language processing service 127 and/or to the compliance detection service 130 that can identify a specific text statement 124 within a script 115 to which the audio signal 118 corresponds. The additional information can also include information about the client, the agent, the devices used to communicate, and/or information about the audio signals 118, such as format or transfer protocols.

Next, at block 315, the agent application 139 can receive a response from the from the compliance detection service 130. Various responses can be received from the compliance detection service 130. For instance, a success response can be received from the compliance detection service 130 that indicates that the audio signal 118 sent at block 306 matches (or has a confidence score that indicates a substantial match) a text statement 124 of the script 115 received at block 309. In another instance, a failure response can be received from the compliance detection service 130 that indicates that the audio signal 118 sent at block 306 does not match (or has a confidence score that is less than a successful match threshold) a text statement 124 of the script 115 received at block 309. In another instance, a re-read response can be received from the compliance detection service 130 that indicates that the agent should re-read or re-vocalize a text statement 124 to generate a second audio signal 118. In various embodiments, the response can include the confidence score calculated by the compliance detection application 130.

In various embodiments, receiving the response can affect the user interface 136 of the display 133. In some embodiments, the response can include one or more words that the compliance detection application 130 has identified as not matching the corresponding text statement 124. In such an embodiment, the agent application 139 can emphasize or highlight the identified words in the text statement 124 on the user interface 136 of the display 133 (see discussion of FIG. 2). In some embodiments, the confirmation affordances 200 and the status indicators 203 of the user interface 136 on the display 133 can be changed, modified, amended, and/or replaced (see discussion of FIG. 2).

Continuing to decision block 318, the agent application 139 can determine if the response indicates that there was a compliance failure for matching the text statement 124. In at least some embodiments, the agent application 139 can determine that a response indicates that there was a compliance failure by recognizing the type of response that was sent by inspecting the response metadata, fields provided in the response, or any data associated with the response. In some embodiments, the agent application 139 can determine that a response indicates that there was a compliance failure by interpreting a confidence score that is included in the response. If a response indicates that there was a compliance failure for matching the text statement 124, then the method can proceed to block 321. If the response indicates that there was not a compliance failure for matching the text statement 124, the method can proceed to block 324.

At block 321, the agent application 139 can prompt the agent to again vocalize or re-read the text statement 124 that the response indicated was a compliance failure or the agent application 139 can re-trigger the compliance service to perform blocks 403-424 to ensure the compliance failure of decision block 318 was not erroneous. In at least some embodiments, when a compliance failure for the audio signal 118 failing to match the text state has occurred, then the agent application 139 can prompt the agent to re-read or again vocalize for the audio signal 118 a specific text statement 124. In some embodiments, a popup can occur to provide notice to an agent. In some embodiments, a status indicator 203 or a confirmation affordance 200 can be modified to indicate to the agent to re-read or again vocalize the text statement 124. After block 321, the method returns to block 312, where the agent can send the text statement 124 to the compliance detection service 130.

In at least another embodiment of block 321, the agent application 139 can re-trigger the compliance service to perform blocks 403-424 to ensure the compliance failure of decision block 318 was not erroneous. In such an embodiment, the agent application 139 can choose to not prompt the agent to again vocalize or re-read the text statement 124. Instead, the audio signal 118 that just failed the compliance failure check at decision block 318 can be re-sent to at least the compliance detection service 130, as discussed at block 312. If after a certain number of compliance failures detected at decision block 318, the agent application 139 can prompt the agent to again vocalize or re-read the text statement 124 that the response indicated was a compliance failure, as previously discussed.

Continuing from block 318, the agent application 139 can determine whether each of the required text statements 124 in the script 115 have successfully passed compliance for the audio communication at decision block 324. In various embodiments, the agent application 139 can evaluate whether each of the required text statements 124 in the script 115 have passed compliance by evaluating the status indicators 203 or confirmation affordances 200. In at least another embodiment, the agent application 139 can perform an inventory of responses received from the compliance detection service 130 to determine that each of the text statements 124 have been read to the client and successfully achieved compliance. If each of the required text statements 124 in the script 115 have successfully passed compliance for the audio communication, then the flowchart of FIG. 3 can come to an end. However, if each of the required text statements 124 in the script 115 have not successfully passed compliance for the audio communication, the method can continue to block 327.

At block 327, the agent application 139 can prompt the agent to read or vocalize a next text statement 124. In some embodiments, a popup can occur to provide notice to an agent that one or more text statements 124 need to be read to the client. In some embodiments, a status indicator 203 or a confirmation affordance 200 can be modified to indicate to the agent should read or vocalize the text statement 124. After block 321, the method returns to block 312, where the agent sends the text statement 124 to the compliance detection service 130.

Referring next to FIG. 4, shown is a flowchart that provides one example of the operation of a portion of the compliance detection service 130. The flowchart of FIG. 4 provides merely an example of the many different types of functional arrangements that can be employed to implement the operation of the depicted portion of the compliance detection service 130. As an alternative, the flowchart of FIG. 4 can be viewed as depicting an example of elements of a method implemented within the network environment 100.

Beginning with block 403, the compliance detection service 130 can receive a text statement 124. In at least some embodiments, the compliance detection service 130 can receive at least a text statement 124 or an identifier for a text statement 124 from the agent application 139. In various embodiments, the compliance detection service 130 can obtain the text statement 124 from the data store 112 based at least on a received identifier for a text statement 124. In at least some embodiments, the compliance detection service 130 can also receive additional information, as described in the discussion of block 312.

Continuing to block 406, the compliance detection service 130 can obtain a transcript 121 of an audio signal 118. In various embodiments, the compliance detection service 130 can obtain the transcript 121 of an audio signal 118 from a natural language processing service 127 base at least on the additional information received at block 403.

In various embodiments, the natural language processing service 127 can perform pre-processing on the audio signals 118, such as noise reduction, filtering, and normalization to improve the quality of the audio signal 118, which can enhance the accuracy of the transcription. In various embodiments, the natural language processing service 127 can perform at least one of the noise reduction, filtering, or normalization repeatedly until the audio signal 118 has a sufficient clarity to begin processing the audio signal 118. Noise reduction can reduce background noise (e.g., a consistent hissing, a consistent humming, a consistent crackle, etc.) in an audio signal 118 with a minimal reduction in audio signal 118 quality. Filtering can be used amplify or boost chosen frequency ranges in the audio signal 118 (e.g., increase the prominence of certain sounds in the audio signal 118, etc.). Filtering can also be used to pass or attenuate chosen frequency ranges in the audio signal 118 (e.g., decrease the prominence of certain sounds in the audio signal 118, etc.). Normalization can increase or decrease the amplitude of an audio signal 118 to bring the amplitude to a target level. The natural language processing service 127 can also perform various other pre-processing transformations to the audio to enhance the clarity and/or concision of the audio signal 118.

In various embodiments, the natural language processing service 127 can perform process on the audio signals 118 to transform the audio into a transcript 121. The natural language processing service 127 can extract relevant features from the audio signal, such as frequency components, phonetic characteristics, and other acoustic information. The natural language processing service 127 can use the extracted features with various algorithms, like Hidden Markov Models, neural networks (including convolutional neural networks or recurrent neural networks), transformers (e.g., Bidirectional Encoder Representations from Transformers (“BERT”), Generative Pre-trained Transformer (“GPT”), etc.), or other models. The natural language processing service 127 can employ language models to improve accuracy by considering context of the words spoken. The natural language processing service 127 can output a transcript 121 in a written form. Because many natural language processing services 127 use best estimates to transcribe audio to text and because people can use language that can be difficult to decipher, a transcript 121 can often include unintended errors, incomplete words, and/or incomplete sentences. The natural language processing service 127 can send the transcript 121 to the compliance detection service 130 to continue the process.

Next, at block 409, the compliance detection service 130 can standardize the transcript 121 into a standardized transcript 121. In some embodiments, standardizing a transcript 121 can involve replacing a number word (e.g., “one,” “two,” etc.) from the transcript 121 with a corresponding number integer (e.g., “1,” “2,” etc.). In some embodiments, standardizing a transcript 121 can involve replacing a symbol word (e.g., “point,” “percent”, etc.) from the transcript with a symbol character (e.g., “,”, “%”, etc.). In some embodiments, standardizing a transcript 121 can involve lemmatizing various words to a standard-form word. For example, the word “do” can be represented in past tense with “did,” as a past participle with “done,” as a present participle with “doing,” and a third-person singular form with “does.” In such an example, standardizing a transcript 121 could include replacing any instance of “did,” “done,” “doing,” or “does” as “do.” In some embodiments, standardizing a transcript 121 can involve replacing a contraction word (e.g., “aren't,” “can't,” “I'm,” “they're,” “she′ll,” etc.) from the transcript with corresponding non-contraction words (e.g., “are not,” “cannot,” “I am,” “they are,” “she will,” etc.). In some embodiments, standardizing a transcript 121 can involve removing extraneous spacing and extraneous punctuation. Because many natural language processing services 127 use best estimates to transcribe audio to text and because people can use language that can be difficult to decipher, a transcript 121 can also include unintended errors, incomplete words, and/or incomplete sentences. In various embodiments, standardizing a transcript 121 can remove unintended errors, incomplete words, and/or incomplete sentences.

Continuing to block 412, the compliance detection service 130 can perform a sequence matching to determine a confidence score that indicates how well the standardized transcript 121 matches the corresponding text statement 124. In various embodiments, the compliance detection service 130 can perform a sequence matching to determine a confidence score, where the confidence score represents a likelihood that the text statement 124 matches the standardized transcript. In some embodiments, the compliance detection service 130 can identify a matching count of text statement words of the text statement that match standardized text words of the standardized transcript, identify a total count of text statement words of the text statement, and calculate the confidence score by finding a ratio of the matching count to the total count.

In at least another embodiment, the compliance detection service 130 can perform a sequence matching to determine a confidence score, where the confidence score representing a likelihood that the text statement matches the standardized transcript by generating a plurality of sliding window confidence scores and calculating the confidence score based on the plurality of sliding window confidence scores. The compliance detection service 130 can generate a plurality of sliding window confidence scores by comparing the standardized transcript to the text statement using a sliding window comparison. The compliance detection service 130 can then calculate the confidence score by averaging the plurality of sliding window confidence scores.

To compare using the sliding window comparison, the compliance detection service 130 can convert the standardized transcript into a first plurality of word sets, each word set of the first plurality of word sets being representative of a fixed number of consecutive words of the standardized transcript. Then, the compliance detection service 130 can convert the text statement into a second plurality of word sets, each word set of the second plurality of word sets being representative of the fixed number of consecutive words of the text statement. Next, the compliance detection service 130 can then associate word sets of the first plurality of word sets to corresponding word sets of the second plurality of word sets. Then, the compliance detection service 130 can compare each word in associated word sets of the first plurality of word sets and the second plurality of word sets to determine a matched word amount for each of the corresponding word sets. To finish the sliding window comparison, the compliance detection service 130 can then generate the plurality of sliding window confidence scores by calculating a percentage of the matched word amount to the fixed number of consecutive words.

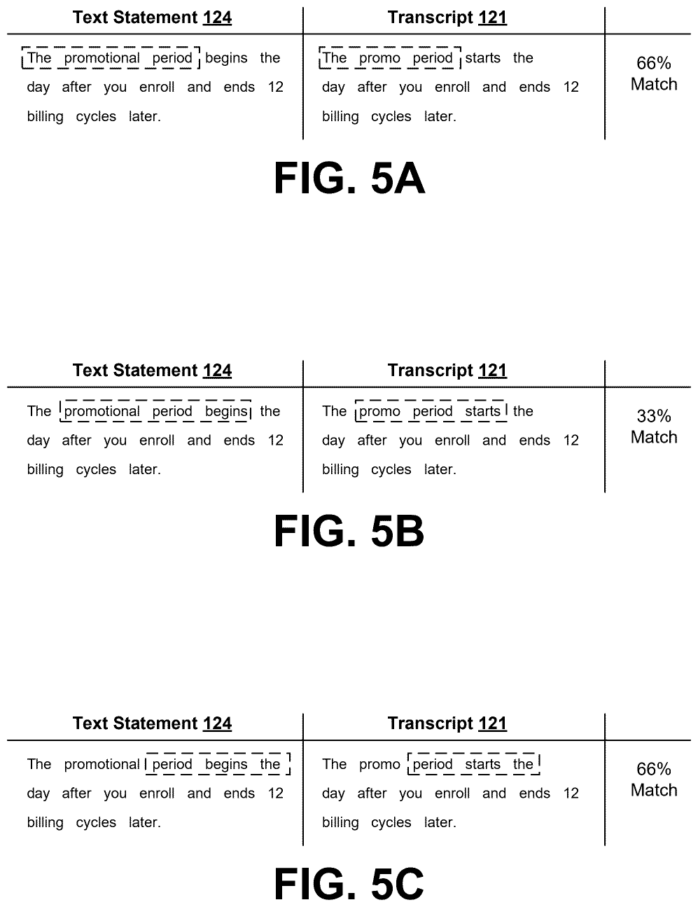

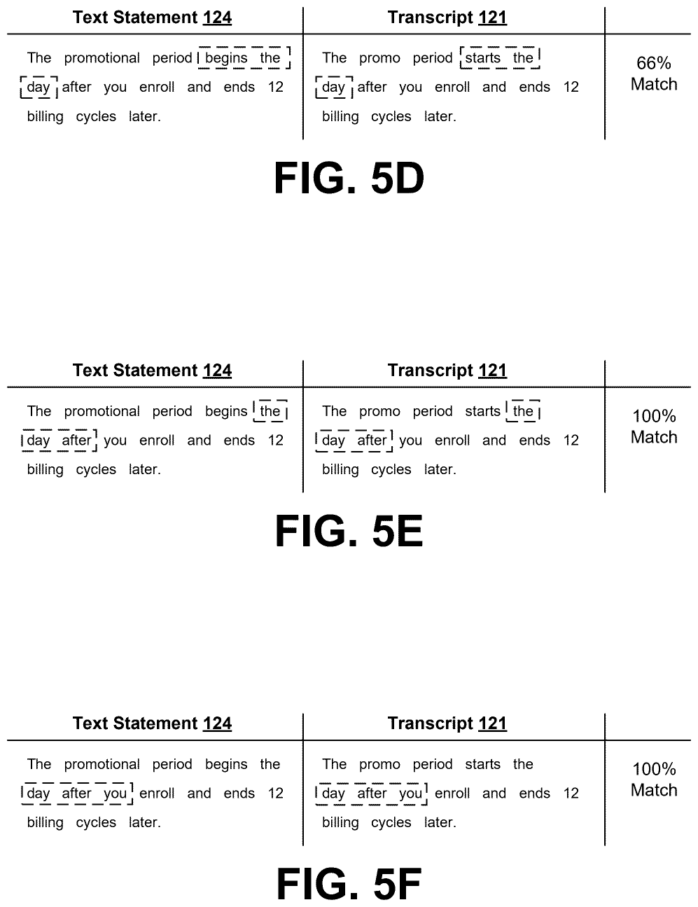

FIGS. 5A-F further explain at least one example of sequence matching using a sliding window comparison. Each of FIGS. 5A-F depict an example text statement 124, an example standardized transcript 121, and a match percentage that corresponds to how much the dashed portions of the example text statement 124 and standardized transcript 121 match. In the example of FIGS. 5A-F, the window size for the sliding window is three words. To start, in FIG. 5A, a text statement sliding window can capture the first three words of the example text statement 124 (i.e., “The promotional period”) and a transcript sliding window can capture the first three words of the transcript 121 (i.e., “The promo period”). The words “The” and “period” match in the text statement sliding window and the transcript sliding window, but the words “promotional” and “promo” do not match. Accordingly, two out of the three words in the respective sliding windows match, which can be represented as sixty-six percent (66%) or as a decimal sixty-six hundredths (0.66).

In FIG. 5B, a text statement sliding window can capture the next three words of the example text statement 124 (i.e., “promotional period begins”) and a transcript sliding window can capture the next three words of the transcript 121 (i.e., “promo period starts”). The word “period” matches in the text statement sliding window and the transcript sliding window, but the words “promotional,” “promo,” “begins,” and “starts” do not match. Accordingly, one out of the three words in the respective sliding windows match, which can be represented as thirty-three percent (33%) or as a decimal thirty-three hundredths (0.33).

In FIG. 5C, a text statement sliding window can capture the next three words of the example text statement 124 (i.e., “period begins the”) and a transcript sliding window can capture the next three words of the transcript 121 (i.e., “period starts the”). The words “period” and “the” matches in the text statement sliding window and the transcript sliding window, but the words “promotional” and “promo” do not match. Accordingly, two out of the three words in the respective sliding windows match, which can be represented as sixty-six percent (66%) or as a decimal sixty-six hundredths (0.66).

In FIG. 5D, a text statement sliding window can capture the next three words of the example text statement 124 (i.e., “begins the day”) and a transcript sliding window can capture the next three words of the transcript 121 (i.e., “starts the day”). The words “the” and “day” matches in the text statement sliding window and the transcript sliding window, but the words “begins” and “starts” do not match. Accordingly, two out of the three words in the respective sliding windows match, which can be represented as sixty-six percent (66%) or as a decimal sixty-six hundredths (0.66).

In FIG. 5E, a text statement sliding window can capture the next three words of the example text statement 124 (i.e., “the day after”) and a transcript sliding window can capture the next three words of the transcript 121 (i.e., “the day after”). All of the words match in the text statement sliding window and the transcript sliding window. Accordingly, three out of the three words in the respective sliding windows match, which can be represented as one hundred percent (100%) or as an integer one (1).

In FIG. 5F, a text statement sliding window can capture the next three words of the example text statement 124 (i.e., “day after you”) and a transcript sliding window can capture the next three words of the transcript 121 (i.e., “day after you”). All of the words match in the text statement sliding window and the transcript sliding window. Accordingly, three out of the three words in the respective sliding windows match, which can be represented as one hundred percent (100%) or as an integer one (1).

If the example shown from FIGS. 5A-F were to continue, every remaining transcript sliding window would match the corresponding text statement sliding windows. This comparison would result in match values that include one instance of thirty-three percent (See FIG. 5B), three instances of sixty-six percent (See FIGS. 5A, 5C, and 5D), and nine instances of one hundred percent (See FIGS. 5E and 5F). A confidence score can be calculated by taking an average of the match values. Accordingly, the confidence score can be calculated for this example as roughly eighty-five percent (˜85%) or as a decimal eighty-five hundredths (0.85) as rounded to the hundredths place.

Returning to FIG. 4, at decision block 415, the compliance detection service 130 can determine whether the confidence score is both greater than a failure threshold value and less than a success threshold value. The compliance detection service 130 can determine that the confidence score is less than a success threshold value and the confidence score is greater than a failure threshold value in response to performing the sequence matching. A success threshold value and a failure threshold value can be in the same format as the confidence score (e.g., percentage, decimal, integer, etc.). A success threshold value represents the minimum value for which a success response can be sent to an agent application 139. A failure threshold value represents the maximum value for which a failure response can be sent to an agent application 139. However, there is a possibility that the success threshold value is greater than the failure threshold value, which leaves a range of values that are neither a success nor a failure. When a confidence score falls within this range, this represents that additional processing on the transcript 121 can be performed to see if the agent has stated the most substantial words in the text statement 124. If the confidence score is both greater than a failure threshold value and less than a success threshold value, then the method can continue to block 418. If the confidence score is either less than the failure threshold value or greater than the success threshold value, then the method can continue to block 424.

Continuing to block 418, the compliance detection service 130 can assign weights to words in the standardized transcript 121. The compliance detection service 130 can assign a weight to a word of the standardized transcript by at least identifying a word of the standardized transcript within a list of weighted keywords, each entry of the list of weighted keywords includes a keyword and a keyword weight. The compliance detection service 130 can continue to assign a weight to a word of the standardized transcript by at least associating the weight to the word when the word matches a first keyword in the list of weighted keywords. In such an embodiment, the first keyword can correspond to a first keyword weight and the first keyword weight is the weight.

Next, at block 421, the compliance detection service 130 can add a value to the confidence score based at least in part on the weight words in the standardized transcript 121. In some embodiments, the compliance detections service 130 can generate an adjusted confidence score by adding an adjustment value to the confidence score. The adjustment value can be determined based at least in part on the weight assigned to the word of the standardized transcript. For example, the compliance detection service 130 can calculate the adjustment value by multiplying a weight assigned to the word by the number of instances of that word. In some embodiments, weight assigned to a word can be a negative weight, which would act as a way to de-emphasize the word in the total score. In some embodiments, the weight assigned to a word can be a positive weight, which would act as a way to emphasize the word in the total score.

Continuing to block 424, the compliance detection service 130 can send a response to the agent application 139 based at least in part on the confidence score (or adjusted confidence score). In various embodiments, the response can include the confidence score calculated by the compliance detection application 130. In at least some embodiments, the compliance detection service 130 can send the response to the agent application 139 in response to generating the adjustment confidence score. In some embodiments, the compliance detection service 130 can send the response in response to performing the sequence matching.

Various responses can be sent from the compliance detection service 130 to the agent application 139. In at least some embodiments, the compliance detection service 130 can determine that the confidence score (or adjusted confidence score) is greater than or equal to the success threshold value and the compliance detection service 130 can then send a success response to the agent application 139. In at least some embodiments, the compliance detection service 130 can determine that the confidence score (or adjusted confidence score) is less than the success threshold value and the compliance detection service 130 can then send a failure response to the agent device.

In some embodiments, the compliance detection service 130 can determine that the confidence score is less than a success threshold value and the confidence score is greater than a failure threshold value. In such embodiments, the compliance detection service 130 can send a message to the agent application 139 directing an agent to send a second audio signal 118 representing another vocalization of a text statement 124.

In some embodiments using sequence matching using a sliding window comparison, the compliance detection service 130 can identify that a first consecutive group of word sets of the first plurality of word sets does not match a second consecutive group of word sets of the second plurality of word sets. By doing so, the compliance detection service 130 can send a message to the agent application 139 directing the agent to re-vocalize or re-read the text statement based on the non-matching words. Once block 424 has completed, the flowchart of FIG. 4 can come to an end.

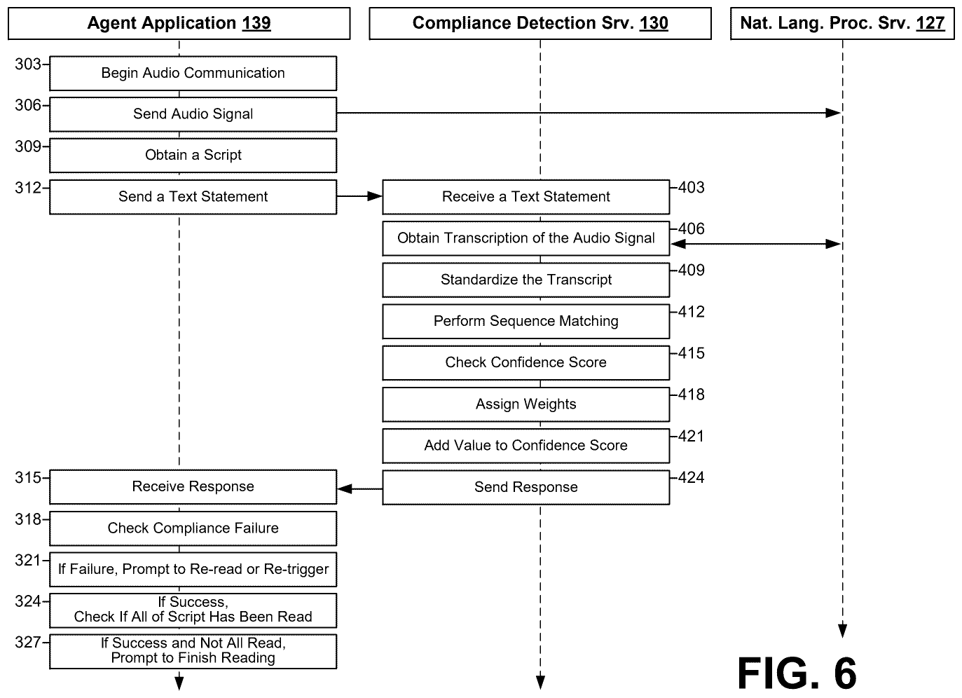

Moving on to FIG. 6, shown is a sequence diagram that provides at least one example of the interactions between the agent application 139, the compliance detection service 130, and the natural language processing service 127. The sequence diagram of FIG. 6 can provide merely an example of the many different types of functional arrangements that can be employed by the agent application 139, the compliance detection service 130, and the natural language processing service 127. As an alternative, the sequence diagram of FIG. 6 can be viewed as depicting examples of elements of one or more method implemented within the network environment 100.

To begin, the agent application 139 can begin an audio communication, as previously described in block 303 of FIG. 3. Next, the agent application 139 can send at least an audio signal 118 to a natural language processing service 127, as previously described in block 306 of FIG. 3. Next, the agent application 139 can obtain a script 115 having one or more text statements 124, as previously described in block 309 of FIG. 3. Next, the agent application 139 can send at least a text statement 124 to the compliance detection service 130, as previously described in block 312 of FIG. 3, which the compliance detection service 130 can receive, as previously described in block 403 of FIG. 4.

Next, the compliance detection service 130 can obtain a transcript 121 for the audio signal 118 from the natural language processing service 127, as previously described in block 406 of FIG. 4. Next, the compliance detection service 130 can standardize the transcript 121 into a standardized transcript 121, as previously described in block 409 of FIG. 4. Next, the compliance detection service 130 can perform a sequence matching to determine a confidence score that indicates how well the standardized transcript 121 matches the corresponding text statement 124, as previously described in block 412 of FIG. 4. Next, the compliance detection service 130 can determine whether the confidence score is both greater than a failure threshold value and less than a success threshold value, as previously described in block 415 of FIG. 4. Next, the compliance detection service 130 can assign weights to words in the standardized transcript 121, as previously described in block 418 of FIG. 4. Next, the compliance detection service 130 can add a value to the confidence score based at least in part on the weight words in the standardized transcript 121, as previously described in block 421 of FIG. 4. Next, the compliance detection service 130 can send a response to the agent application 139 based at least in part on the confidence score, as previously described in block 424 of FIG. 4, which the agent application 139 can receive, as previously described in block 315 of FIG. 3.

Next, the agent application 139 can determine if the response indicates that there was a compliance failure for matching the text statement 124, as previously described in block 318 of FIG. 3. Next, the agent application 139 can prompt the agent to again vocalize or re-read the text statement 124 that the response indicated was a compliance failure or re-trigger the compliance detection service 130 to ensure the previous statement actually has failed the compliance check, as previously described in block 321 of FIG. 3. Next, the agent application 139 can determine whether each of the required text statements 124 in the script 115 have successfully passed compliance for the audio communication, as previously described in block 324 of FIG. 3. Next, the agent application 139 can prompt the agent to read or vocalize a next text statement 124, as previously described in block 327 of FIG. 3. Subsequently, the sequence diagram of FIG. 6 can come to an end.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random access portion of the memory and run by the processor, source code that can be expressed in proper format such as object code that is capable of being loaded into a random access portion of the memory and executed by the processor, or source code that can be interpreted by another executable program to generate instructions in a random access portion of the memory to be executed by the processor. An executable program can be stored in any portion or component of the memory, including random access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random-access memory (SRAM), dynamic random-access memory (DRAM), or magnetic random-access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts and sequence diagram show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowcharts and sequence diagram show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts and sequence diagram can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random-access memory (RAM) including static random-access memory (SRAM) and dynamic random-access memory (DRAM), or magnetic random-access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment 103.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
a computing device comprising a processor and a memory; and
machine-readable instructions stored in the memory that, when executed by the processor, cause the computing device to at least:
receive an audio signal representing at least a spoken statement;
receive a text statement;
transcribe the audio signal into a transcript;
standardize the transcript into a standardized transcript; and
perform a sequence matching to determine a confidence score, the confidence score representing a likelihood that the text statement matches the standardized transcript.

2. The system of claim 1, wherein the machine-readable instructions further cause the computing device to at least:
determine, in response to performing the sequence matching, that the confidence score is less than a success threshold value and the confidence score is greater than a failure threshold value;
assign a weight to a word of the standardized transcript; and
generate an adjusted confidence score by adding an adjustment value to the confidence score, the adjustment value being based at least in part on the weight assigned to the word of the standardized transcript.

3. The system of claim 2, wherein the machine-readable instructions further cause the computing device to at least:
determine, in response to generating the adjustment confidence score, that the adjusted confidence score is greater than or equal to the success threshold value; and
send, to an agent device, a success response.

4. The system of claim 2, wherein the machine-readable instructions further cause the computing device to at least:
determine, in response to generating the adjustment confidence score, that the adjusted confidence score is less than the success threshold value; and
send, to an agent device, a failure response.

5. The system of claim 2, wherein the machine-readable instructions that assign the weight to the word of the standardized transcript, when executed by the processor, further cause the computing device to at least:
identify the word of the standardized transcript within a list of weighted keywords, each entry of the list of weighted keywords includes a keyword and a keyword weight; and
associate the weight to the word, wherein the word matches a first keyword in the list of weighted keywords, the first keyword corresponds to a first keyword weight, and the first keyword weight is the weight.

6. The system of claim 1, wherein the audio signal is a first audio signal, the spoken statement is a first spoken statement, and the machine-readable instructions further cause the computing device to at least:
determine, in response to performing the sequence matching, that the confidence score is less than a success threshold value and the confidence score is greater than a failure threshold value; and
send, to an agent device, a message directing an agent to send a second audio signal representing at least a second spoken statement.

7. The system of claim 1, wherein the machine-readable instructions that perform the sequence matching to determine the confidence score, when executed by the processor, further cause the computing device to at least:
identify a matching count of text statement words of the text statement that match standardized text words of the standardized transcript;
identify a total count of text statement words of the text statement; and
calculate the confidence score by finding a ratio of the matching count to the total count.

8. The system of claim 1, wherein the machine-readable instructions that perform the sequence matching to determine the confidence score, when executed by the processor, further cause the computing device to at least:
generate a plurality of sliding window confidence scores by comparing the standardized transcript to the text statement using a sliding window comparison; and
calculate the confidence score by averaging the plurality of sliding window confidence scores.

9. The system of claim 1, wherein the machine-readable instructions that standardize the transcript into the standardized transcript, when executed by the processor, further cause the computing device to at least:
replace a number word from the transcript with a corresponding number integer; and
replace a symbol word from the transcript with a symbol character.

10. A method, comprising:
obtaining a transcript of an audio signal representing at least a spoken statement;
standardizing the transcript into a standardized transcript; and
performing a sequence matching to determine a confidence score, the confidence score representing a likelihood that a text statement matches the standardized transcript.

11. The method of claim 10, wherein performing the sequence matching to determine the confidence score further comprises:
generating a plurality of sliding window confidence scores by comparing the standardized transcript to the text statement using a sliding window comparison; and
calculating the confidence score by averaging the plurality of sliding window confidence scores.

12. The method of claim 11, wherein the sliding window comparison comprises:
converting the standardized transcript into a first plurality of word sets, each word set of the first plurality of word sets being representative of a fixed number of consecutive words of the standardized transcript;
converting the text statement into a second plurality of word sets, each word set of the second plurality of word sets being representative of the fixed number of consecutive words of the text statement;
associating word sets of the first plurality of word sets to corresponding word sets of the second plurality of word sets;
comparing each word in associated word sets of the first plurality of word sets and the second plurality of word sets to determine a matched word amount for each of the corresponding word sets; and
generating the plurality of sliding window confidence scores by calculating a percentage of the matched word amount to the fixed number of consecutive words.

13. The method of claim 12, further comprising:
identifying that a first consecutive group of word sets of the first plurality of word sets does not match a second consecutive group of word sets of the second plurality of word sets; and
sending, to an agent device, a message directing an agent to send a second audio signal representing specified words in the second consecutive group of word sets.

14. The method of claim 10, further comprising:
determining, in response to performing the sequence matching, that the confidence score is less than a success threshold value and the confidence score is greater than a failure threshold value;
assigning a weight to a word of the standardized transcript; and
generating an adjusted confidence score by adding an adjustment value to the confidence score, the adjustment value being based at least in part on the weight assigned to the word of the standardized transcript.

15. The method of claim 10, wherein standardizing the transcript into the standardized transcript further comprises replacing a variant-form word to a standard-form word.

16. The method of claim 10, wherein standardizing the transcript into the standardized transcript further comprises replacing a contraction word from the transcript with corresponding non-contraction words.

17. The method of claim 10, wherein standardizing the transcript into the standardized transcript further comprises removing extraneous spacing and extraneous punctuation.

18. A non-transitory, computer-readable medium, comprising machine-readable instructions that, when executed by a processor of a computing device, cause the computing device to at least:
obtain a transcript of an audio signal representing at least a spoken statement;
standardize the transcript into a standardized transcript; and
perform a sequence matching to determine a confidence score, the confidence score representing a likelihood that a text statement matches the standardized transcript.

19. The non-transitory, computer-readable medium of claim 18, wherein the machine-readable instructions, when executed by the processor, further cause the computing device to at least:
determine, in response to performing the sequence matching, that the confidence score is less than a success threshold value and the confidence score is greater than a failure threshold value;
assign a weight to a word of the standardized transcript; and
generate an adjusted confidence score by adding an adjustment value to the confidence score, the adjustment value being based at least in part on the weight assigned to the word of the standardized transcript.

20. The non-transitory, computer-readable medium of claim 18, wherein the machine-readable instructions that perform the sequence matching to determine the confidence score, when executed by the processor, further cause the computing device to at least:
generate a plurality of sliding window confidence scores by comparing the standardized transcript to the text statement using a sliding window comparison; and
calculate the confidence score by averaging the plurality of sliding window confidence scores.
